(19) United States
(12) Patent Application Publication
(10) Pub. No.: US 2026/0070243 A1
(43) Pub. Date: Mar. 12, 2026

(54) HYDRAULIC POWER TOOL WITH USER ACTUATED SEQUENCE VALVE

(71) Applicant: Milwaukee Electric Tool Corporation, Brookfield, WI (US)

(72) Inventors: Daniel Garces, Waukesha, WI (US); Brandon Meister, Brookfield, WI (US); Kris J. Kanack, Whitewater, WI (US)

(21) Appl. No.: 19/326,049

(22) Filed: Sep. 11, 2025

Related U.S. Application Data
(60) Provisional application No. 63/693,358, filed on Sep. 11, 2024.

(51) Int. Cl. B26B 15/00; B25F 5/00

(52) U.S. Cl. CPC B26B 15/00; B25F 5/005

(57) ABSTRACT

A power tool comprises a cylinder and a ram movably received in the cylinder to define a first chamber and a second chamber. A pump to supply fluid to the first chamber and the second chamber. A sequence valve is operable between a first configuration to cause the pump to supply fluid to the first chamber to move the ram at a first speed and a second configuration to cause the pump to supply fluid to the second chamber to move the ram at a second speed. A user interface is manually actuatable by a user to move the sequence valve between the first configuration and the second configuration independently of the pressure in the first chamber.

### CROSS-REFERENCE TO RELATED APPLICATIONS

This application claims priority to and the benefit of U.S. Provisional Application No. 63/693,358, filed on Sep. 11, 2024, which is incorporated herein by reference in its entirety.

### BACKGROUND

Crimpers and cutters often include a crimping head with opposed jaws that include certain crimping and cutting features, depending on the particular configuration of the tool. Some crimpers and cutters are hydraulic power tools that include a piston that can exert force on the crimping or cutting head, which may be used for closing the jaws to perform crimp, compression, or cutting work at a targeted location. A valve can be used to direct hydraulic fluid, including high pressure hydraulic fluid, in and out of chambers of the piston.

### SUMMARY

A power tool can include a sequence valve to control extension of a ram at different speeds. For example, a ram can move at a first speed for a first portion of a stroke and can switch to move at a second speed for a second portion of the stroke. A sequence valve can be provided to switch the ram movement between the first speed and the second speed based on a pressure of hydraulic fluid or via manual activation of the sequence valve by a user.

In some aspects, a power tool can include a cylinder and a ram movably received in the cylinder to define a first chamber and a second chamber. A pump can supply fluid to the first chamber and the second chamber. A sequence valve can be operable between a first configuration to cause the pump to supply fluid to the first chamber to move the ram at a first speed and a second configuration to cause the pump to supply fluid to the second chamber to move the ram at a second speed. The sequence valve can move from the first position to the second position based on a pressure in the first chamber. A user interface can be manually actuatable by a user to move the sequence valve between the first configuration and the second configuration independently of the pressure in the first chamber.

In some examples, the sequence valve can include a poppet that moves based on the pressure in the first chamber or by actuation of the user interface.

In some examples, the power tool can further include a housing that receives the cylinder, and the poppet can include a plunger that extends outside of the housing to be actuated by a user.

In some examples, the user interface can be configured as one of a lever, a slider, a button, and a solenoid that applies an external force to the poppet.

In some examples, the user interface can be directly mechanically coupled to the poppet.

In some examples, the user interface can be mechanically coupled to the poppet via a linkage.

In some examples, the user interface can be in communication with an electronic controller that activates an electronic actuator to move the poppet.

In some examples, the sequence valve can attain the second configuration when the pressure in the first chamber reaches a threshold pressure and independently of actuation of the user interface.

In some examples, the power tool can further include a work head coupled to the ram to perform at least one of a crimping and a cutting operation.

In some aspects, a power tool can include an actuator and a pump to supply fluid to the actuator to cause the actuator to extend or retract. The pump can define an opening. A sequence valve can include a valve body positioned in the opening in the pump, a control element moveable within the valve body between a first position and a second position, and a plunger that extends out of the valve body and can be configured to receive a user input. The user input can cause the control element to move between the first position and the second position to change a speed of the actuator between a first speed and a second speed.

In some examples, the user input can be provided at a user interface component that can be coupled to the plunger.

In some examples, the user interface component can include a mechanical linkage.

In some examples, the user interface component can include an electronic actuator.

In some examples, the control element can move from the first position to the second position based on a pressure of the fluid supplied to the first chamber independently of the user input.

In some examples, the control element can be a poppet that can be engaged with a seat in the valve body in the first position and disengaged from the seat in the second position.

In some examples, the fluid can be supplied to only a first chamber of the actuator when the poppet can be in the first position, and the fluid can be supplied to both the first chamber and a second chamber of the actuator when the poppet can be in the second position.

In some aspects, a method of operating a hydraulic power tool can include actuating a first user interface of the hydraulic power tool to supply fluid from a pump to a first fluid chamber to move a ram at a first speed. The method can include manually actuating a second user interface to move a poppet of a sequence valve from a closed position to an open position to supply fluid from the pump to a second fluid chamber to move the ram at a second speed that can be different from the first speed. The second user interface can be actuatable independently of a pressure in the first fluid chamber.

In some examples, manually actuating the second user interface can include actuating a mechanical linkage that directly engages the poppet to move the poppet from the closed position to the open position.

In some examples, the mechanical linkage can include one of a sliding switch, a lever switch, or a button that mechanically displaces the poppet against a biasing force of a spring.

In some examples, manually actuating the second user interface can include operating an electronic switch that causes an electronic actuator to move the poppet from the closed position to the open position.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 illustrates a perspective view of a hydraulic tool, according to an example embodiment;

FIG. 2 illustrates a block diagram of the hydraulic tool illustrated in FIG. 1;

FIG. 3 illustrates another block diagram of components of the hydraulic tool illustrated in FIG. 1;

FIG. 4 illustrates a cross-sectional view of the hydraulic tool illustrated in FIG. 1;

FIG. 5 illustrates an enlarged cross-sectional view of the hydraulic tool illustrated in FIG. 1, taken at area V-V of FIG. 4;

FIG. 6 illustrates an enlarged cross-sectional view of a sequence valve of the hydraulic tool of FIG. 1, in a closed position.

FIG. 7 illustrates an enlarged cross-sectional view of the sequence valve of FIG. 6, in an open position.

FIG. 8 illustrates an enlarged cross-sectional view of a sequence valve of the hydraulic tool of FIG. 1, in a closed position.

FIG. 9 illustrates an enlarged cross-sectional view of the sequence valve of FIG. 9, in an open position.

FIG. 10 illustrates an enlarged cross-sectional view of a sequence valve of the hydraulic tool of FIG. 1, in a closed position.

FIG. 11 illustrates an enlarged cross-sectional view of the sequence valve of FIG. 10, in an open position.

FIG. 12 illustrates a flowchart of an example crimping method utilizing a hydraulic tool, according to an example embodiment.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

As briefly described above, hydraulic tools can be used to perform cuts, crimps, or press work on a workpiece, such as on a pipe, a cable, or a connector, for example. Generally, hydraulic tools include a cylinder and piston configuration, where a piston is configured to extend and retract within a cylinder, and thus, move jaws, or any other implement coupled to the piston to perform a task (crimping, cutting, punching, etc.). Hydraulic fluid can be directed in and out of chambers of the cylinder and piston configuration to cause the piston to extend and retract. The hydraulic fluid can generally displace the cylinder or piston to actuate a work head to press, lift, crimp, cut, punch, or otherwise perform an action on a work piece retained.

Conventional hydraulic tools generally displace the cylinder or piston toward the work head at a single speed, until the work head contacts the workpiece retained within the work head. In some applications, the single speed of the cylinder or piston can be undesirable, and the work head may be actuated to cut or crimp the workpiece too fast, creating excess difficulty for workers attempting to properly align the work head at a desired crimp, cut, or punch location on the workpiece. Additionally, hydraulic pressing tools or lifting tools may also suffer from a lack of speed control and operational precision. As such, there is a general need for a hydraulic tool that enables selective speed adjustment of the piston, and therefore speed adjustment of the actuating work head, to case the task of aligning the work head relative to the desired lift, press, crimp, cut, or punch location.

Generally, embodiments of the invention provide a hydraulic tool, including a pump, a piston, and a work head. The pump may supply one or more of a plurality of hydraulic fluid chambers to extend the piston and thus actuate the work head. The pump may supply fluid to a first chamber of the hydraulic fluid chambers. Supplying the first chamber with fluid may cause the piston to extend at a first rate. In some examples, the pump may additionally supply fluid to a second chamber of the hydraulic fluid chambers. Simultaneously supplying fluid to the first chamber and the second chamber may cause the piston to extend at a second rate that is slower than the first rate, thus modulating a speed of the piston, and therefore of the actuation of the work head.

Some embodiments of the invention provide a sequence valve. More particularly, some embodiments of the invention provide a sequence valve that is selectively actuatable by a user to manage a speed of a piston of a hydraulic tool. This gives a user additional control over tool operation, as compared with conventional designs where the sequence valve is internal to the tool and operable based only on a pressure in the cylinder. In accordance with aspects of the disclosure, the sequence valve can be actuatable by the user to selectively allow fluid communication between the pump and the second chamber of the hydraulic fluid chambers. Actuation of the sequence valve may therefore slow an extension rate of the piston and an actuation rate of the work head. Such “on-demand” actuation of the sequent valve can be controlled by the user through an actuating element of the sequence valves. Actuating elements can be manual actuating elements, for example, a button, lever, toggle, slide, etc., or electronic actuating elements, such as electrical switch or other control interface that can be coupled to, for example, a solenoid, linear actuator, etc.

Embodiments of the sequence valve described herein include a valve assembly having a poppet. The poppet can regulate fluid communication between the pump of the hydraulic tool and the second chamber. In use, the poppet can be biased toward a closed position by a spring. The poppet can be automatically actuated to an open position by a fluid pressure (e.g., from the pump), counteracting the force of the spring. The poppet can also be selectively actuated by the user to the open position by a button, switch, slide, or other user interface.

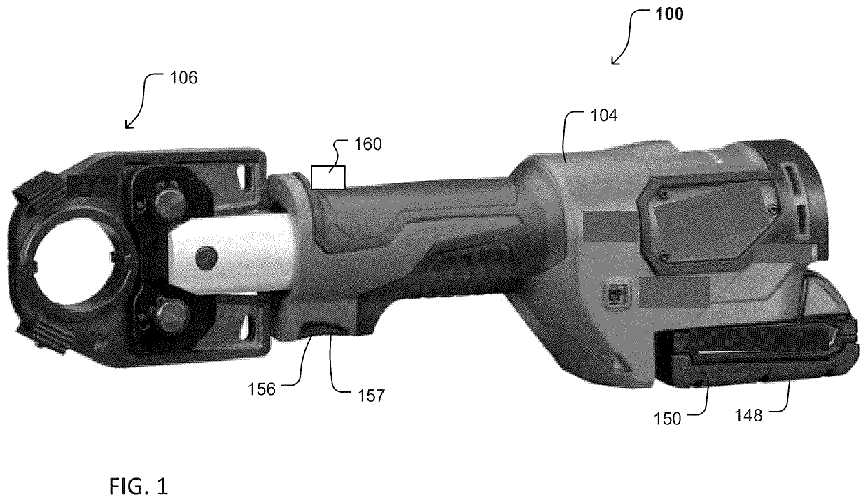

FIG. 1 illustrates a hydraulic tool 100 (i.e., a power tool), in accordance with an example implementation. Although the example implementation described herein references a crimping tool, it should be understood that the features of this disclosure can be implemented in other similar tools, such as cutting tools or punching tools. In addition, any suitable size, shape or type of elements or materials could be used. As just one example, the illustrated hydraulic tool 100 comprises a body 102 (e.g., a cylinder, a motor, a reservoir, electronics, etc.) and a work head 106. The body 102 can be disposed within a housing 104 and the work head 106 can extend from the housing 104 to engage with a workpiece. In the illustrated example, the work head 106 is a hex or six-sided crimping head. However, alternative styled work heads may also be used for crimping, cutting, or punching, including, blades, jaws, crimping dies, etc.

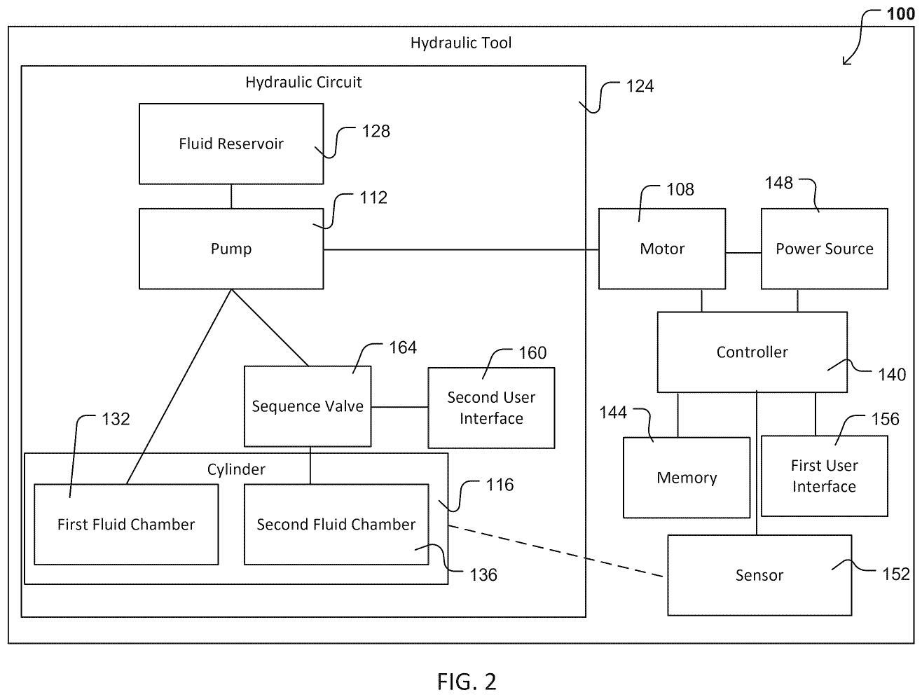

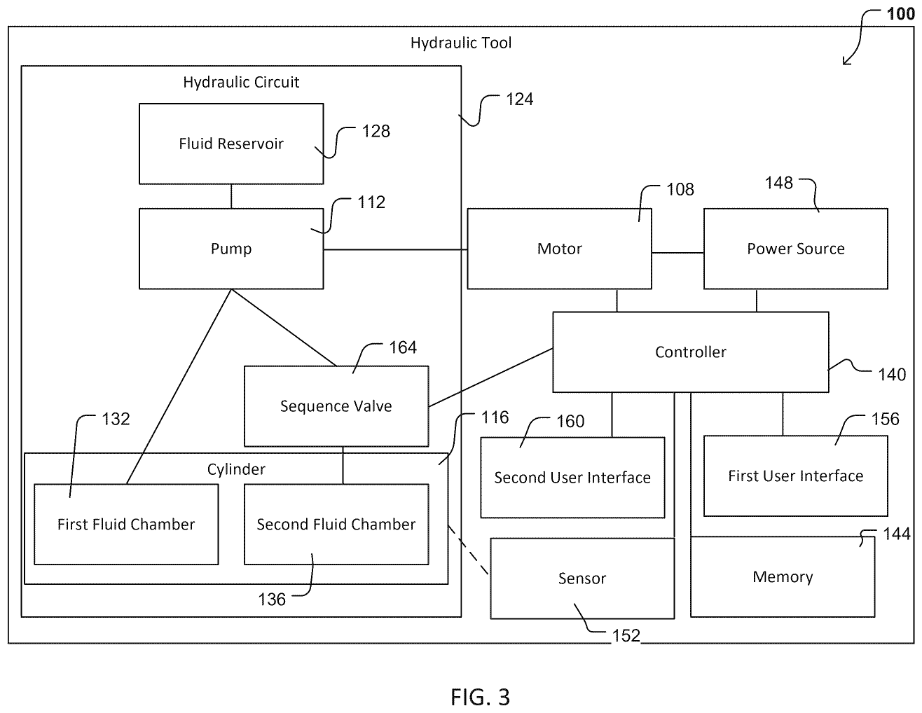

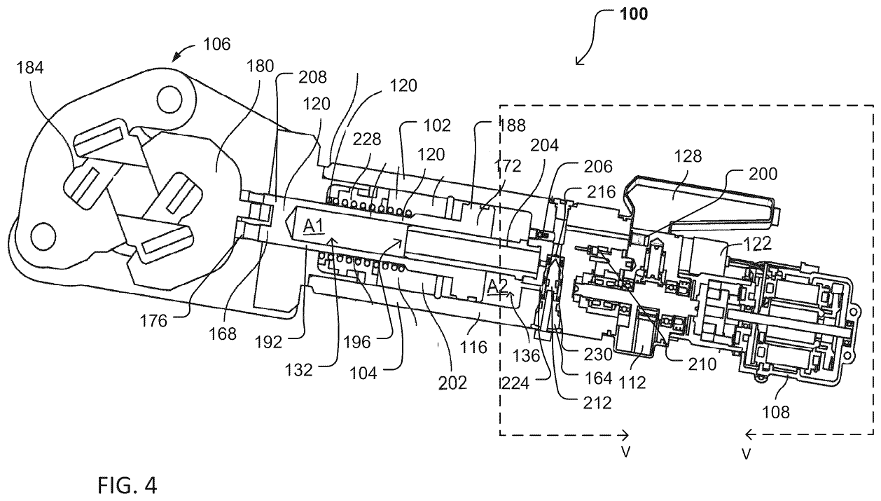

FIGS. 2 and 3 illustrate a block diagram of components of the hydraulic tool 100 illustrated in FIGS. 1, 4, and 5. As illustrated in FIG. 2, the hydraulic tool 100 includes an electric motor 108 configured to drive a pump 112. The pump 112 is configured to provide pressurized hydraulic fluid to one or more hydraulic fluid chambers of a hydraulic actuator cylinder 116, which includes a piston 120 slidably accommodated therein (as shown in FIG. 4). For example, a hydraulic circuit 124 of the tool 100 may connect a fluid reservoir 128 to the pump 112, so that the pump 112 may supply fluid to a first fluid chamber 132 and/or a second fluid chamber 136. As described further below, selectively supplying fluid to the first fluid chamber 132 and/or the second fluid chamber 136 may modulate an actuation speed of the piston 120 within the hydraulic actuator cylinder 116.

In some examples, some functions of hydraulic tools can be controlled by a computing device. For example, the hydraulic tool can include a controller 140. The controller 140 may include a processor, a memory 144, and a communication interface. The memory 144 may include instructions that, when executed by the processor, cause the controller 140 to operate the tool 100. In one arrangement, the controller communication interface enables the controller 140 to communicate with various components of the tool 100 such as user interface components, the motor 108, memory 144, a power source 148, one or more sensors 152, and various components of the hydraulic circuit 124 (see, e.g., FIG. 3). The power source 148 may be a battery that may be removably connected to a portion of the hydraulic tool, such as a battery receptacle 150 of the housing 104 of the hydraulic tool. The battery may be a rechargeable lithium-ion battery pack, nickel-metal hydride battery, or other suitable power source capable of providing sufficient voltage and current to operate the motor 108 and controller 140. The battery receptacle 150 may include electrical contacts, locking mechanisms, and safety features to ensure secure connection and prevent accidental disconnection during operation.

As illustrated in FIG. 2, the hydraulic tool 100 may include a plurality of user interface components that allow user inputs to the tool 100. As will be described below, the user interface components may be used to operate functions of the hydraulic tool 100. Specifically, a first user interface component 156, here, shown as a trigger 157, may be actuatable to activate the motor 108 and therefore drive the piston 120. In some examples, the first user interface component 156 may be linked to the controller 140. For example, the trigger 157 can engage a switch coupled to the controller 140. In such examples, actuating the trigger 157 may cause the controller 140 to receive a signal indicating user activation, and in response, the controller 140 can send control signals to actuate the motor 108, thereby initiating operation of the pump 112 to supply pressurized hydraulic fluid to the cylinder 116 for extending the piston 120 and actuating the work head 106. In some cases, a first user interface component 156 may comprise other types of controls for a user, including for example, an operator panel, one or more switches, one or more push buttons, one or more interactive indicating lights, soft touch screens or panels, levers, slides and other types of similar switches such as a trigger switch.

Still referring to FIG. 2, the hydraulic tool 100 may further include a second user interface component 160. In some examples, the second user interface component 160 may modulate a speed of actuation of the piston 120, as shown in FIG. 4. Specifically, the second user interface component 160 may be actuated to selectively open and close a sequence valve 164 positioned between the pump 112 and the second fluid chamber 136. As will be described further below, opening the sequence valve 164 may adjust a speed of the hydraulic actuator cylinder 116 (shown in FIG. 1).

In some examples, the second user interface component 160 may provide direct manual control over the sequence valve 164, allowing a user to override the automatic pressure-based operation and manually switch the hydraulic tool 100 from operating at the first speed to the second speed. When the sequence valve 164 is in a closed position, the pump 112 supplies fluid primarily to the first fluid chamber 132, causing the piston 120 to extend at the first speed. By actuating the second user interface component 160, the user may manually open the sequence valve 164, which allows fluid communication between the pump 112 and the second fluid chamber 136.

The manual actuation of the second user interface component 160 may enable the user to switch to the second speed at any desired point during the piston stroke, rather than waiting for the fluid pressure to reach a predetermined threshold that would automatically open the sequence valve 164. This user-controlled switching capability may provide enhanced operational flexibility, allowing the operator to slow down the piston movement when approaching a workpiece or when precise positioning is required, regardless of the current pressure conditions in the hydraulic system.

In some cases, the second user interface component 160 may be configured as a momentary control, where the sequence valve 164 remains open only while the user actively engages the interface component. Alternatively, the second user interface component 160 may be configured as a latching control that maintains the sequence valve 164 in the open position until the user releases or deactivates the interface component. The manual control provided by the second user interface component 160 may allow operators to adapt the tool's speed characteristics to specific work requirements or personal preferences during operation.

In some cases, the sequence valve 164 can open based on manual activation by a user or when a pressure of the hydraulic fluid exceeds a predetermined pressure. For example, when the hydraulic fluid pressure in the first chamber reaches the predetermined pressure threshold, the fluid pressure acts on the poppet of the sequence valve, exerting a force that overcomes the biasing force of the spring, thereby automatically moving the poppet from the closed position to the open position and allowing fluid communication between the pump and the second chamber.

As illustrated in FIG. 2, in some examples, the second user interface component 160 may be directly or otherwise physically connected to the sequence valve 164. For example, as described further below, the second user interface component 160 may be a switch, lever, slide, or trigger that manually acts on a poppet of the sequence valve 164 to move the sequence valve 164 to an open position. The direct physical connection or indirect connection via a linkage or other mechanical system between the second user interface component 160 and the sequence valve 164 provides immediate actuation without requiring electronic control systems or intermediate actuators. This mechanical coupling ensures reliable operation even in harsh working environments where electronic components might be susceptible to damage from vibration, moisture, or electromagnetic interference. The physical connection may be achieved through various mechanical arrangements, such as a direct or indirect push-pull mechanism where the second user interface component 160 directly contacts and displaces the poppet, or through a linkage system that translates user input motion into the required valve actuation movement. In some implementations, the physical connection may include mechanical advantage features, such as lever ratios or cam profiles, which reduce the force required by the user to actuate the sequence valve while maintaining precise control over valve operation. The direct mechanical connection also provides tactile feedback to the user, allowing the operator to feel the valve's response and confirm successful actuation through the physical resistance and movement characteristics of the connected components.

Referring briefly to FIG. 3, in some examples, the second user interface component 160 may be linked to the controller 140 through electronic communication pathways. For example, as described further below, the second user interface component 160 may be a switch, lever, slide, or trigger that when actuated may cause the controller 140 to actuate the sequence valve 164 to the open position. For example, the controller 140 can receive an electrical signal indicating user activation. In response to receiving this signal, the controller 140 can process the input and generate appropriate control commands to actuate the sequence valve 164 to the open position via a solenoid, a linear actuator, a motor, or some other type of electronically controlled actuator. This electronic control arrangement allows for precise timing and control of the sequence valve operation, and may include additional features such as programmable delay settings, variable actuation speeds, or integration with other tool functions. The controller 140 may also monitor the status of the sequence valve 164 and provide feedback to the user through visual indicators, audible signals, or haptic feedback mechanisms. Furthermore, the electronic linkage between the second user interface component 160 and the controller 140 enables the implementation of safety interlocks, operational modes, and that can enhance performance of the hydraulic tool 100.

FIG. 4 provides an example implementation of a hydraulic circuit according to aspects of the invention. In this illustrated hydraulic tool example, a frame and a bore of the tool 100 form the hydraulic actuator cylinder 116. The piston 120 of the hydraulic actuator cylinder 116 has a first piston end 168 and a second piston end 172 opposite the first piston end 168. At the first piston end 168, the piston 120 is coupled to a link mechanism 176 that is configured to actuate the work head 106. Specifically, the piston 120 is configured to drive a moveable work head 180 toward a stationery work head 106 to perform a task on a workpiece retained within the work head 106 (e.g., cutting, crimping, punching, or other work). When the piston 120 of the hydraulic actuator cylinder 116 is retracted, the moveable head 180 may be pulled back to a fully retracted or a home position as shown in FIGS. 1 and 4. Alternatively, the moveable head 180 may be pulled back to a partially retracted position.

When pressurized fluid is provided to the cylinder 116 by way of the pump 112, the fluid acts on the piston 120 inside the cylinder 116, and causes the piston 120 to extend toward the workpiece within a work area of the work head 106. Specifically, the pressurized fluid is supplied into the first fluid chamber 132 or the second fluid chamber 136 of the cylinder 116, and the fluid within one or more of the chambers 132, 136 may provide a force configured to extend the piston 120. As the piston 120 extends, the link mechanism 176 causes the moveable work head 180 to move towards the stationary head 184, and may therefore cause the working heads 180, 184 to act upon a workpiece that has been placed between the working heads 180, 184. When the crimping, cutting, or punching operation is completed, the controller 140 can provide instructions to the hydraulic circuit 124 to stop the motor 108 and thereby release the high-pressure fluid back to a fluid reservoir 128 as described in greater detail herein.

As mentioned above, to increase performance of the hydraulic tool 100, such as by increasing piston speed to reduce cycle time, it may be desirable to have a tool where the piston 120 could move at non-constant or different speeds and apply different loads based on a state of the tool, the crimping operation, and/or the type of crimp that is desired. For example, it may be advantageous to move the piston at a first speed (e.g., a fast speed) prior to contact with a workpiece, as can reduce travel time of the piston prior to a crimp occurring. This rapid approach speed allows operators to position the tool quickly and efficiently, reducing overall cycle time and improving productivity. Once the work head contacts a workpiece, it can be advantageous to slow the speed and increase the force output to perform a crimp, as may allow for more accurate crimping. The slower, high-force operation provides better control over the crimping process, ensuring proper compression and connection integrity. This dual-speed operation is particularly beneficial when working with different materials or connector types that may require varying levels of precision and force. The variable speed capability also enables the tool to adapt to different workpiece geometries and material properties, optimizing the crimping process for each specific application.

Referring still to FIG. 4, as described above, the piston 120 can be moveably accommodated within the cylinder 116. The piston 120 includes a piston head 188 and a piston rod 192 extending from the piston head 188 along a central axis direction of the cylinder 116. As shown, the piston 120 is partially hollow. Particularly, the piston head 188 and the piston rod 192 are at least partially hollow to form a cavity 196 within the piston 120. The cavity 196 may extend from the second piston end 172 toward the first piston end 168.

In some examples, the motor 108 may drive the pump 112 to provide pressurized fluid through a check valve 200 to an extension cylinder 204. The extension cylinder 204 is disposed in the cylindrical cavity 196 formed within the partially hollow piston 120. Specifically, the extension cylinder 204 extends from an end of the cylinder 116 opposite the work head 106, and through the second piston end 172. The piston 120 can be configured to slide axially about an external surface of the extension cylinder 204. However, the extension cylinder 204 may be affixed to the cylinder 116 so that the extension cylinder 204 does not move with the piston 120.

In some examples, the piston 120, and particularly the piston rod 192, may further include or may otherwise be coupled to a ram 208. As illustrated in FIG. 4, the ram 208 can be coupled to the moveable work head 180 via the link mechanism 176. Thus, movement of the piston 120 may drive the ram 208 to actuate the moveable work head 180.

Together the piston 120 and the extension cylinder 204 may divide an inside of the cylinder 116 into two chambers: the first fluid chamber 132 and the second fluid chamber 136. The first fluid chamber 132 is formed within a combination of the cylindrical cavity 196 of the hollow piston 120 and the extension cylinder 204. The second chamber 136 is formed between a surface of the piston head 188 that faces toward the motor 108 and the pump 112 (e.g., away from the work head 106), the external surface of extension cylinder 204, and a wall of the cylinder 116. Respective volumes of the first fluid chamber 132 and the second fluid chamber 136 may vary as the piston 120 moves linearly within the cylinder 116.

The pump 112 is configured to draw fluid from the fluid reservoir 128 to pressurize the fluid and deliver the fluid to the extension cylinder 204 after a user initiates a work command. The work command may by initiated by the user entering a command on the user interface components (shown in FIG. 2). For example, a crimp command could be initiated by the user entering a crimp command by way of the first user interface component 156.

The reservoir 128 may include fluid at a pressure close to atmospheric pressure, e.g., a pressure of 15-20 pounds per square inch (psi). Initially, the pump 112 provides low pressure fluid to the first fluid chamber 132 of the extension cylinder 204. Specifically, the fluid may flow through the check valve 200 to the first fluid chamber. However, the fluid may be blocked from flowing into the second fluid chamber 136 by a high-pressure check valve 206 and the sequence valve 164.

The fluid delivered to the first fluid chamber 132 can apply pressure on a first area A1 within the piston 120. As illustrated, the first area A1 can be defined within the cylindrical cavity 196 (e.g., an end thereof) adjacent the first piston end 168. The fluid causes the piston 120 and the ram 208 coupled thereto to advance rapidly. Particularly, when the pump 112 delivers a flow rate of the fluid into the first fluid chamber 132 that is Q, the piston 120 and the ram 208 may move at a speed equal to V1, where V1 could be calculated using the following equation:

$${V}_{1} = \frac{Q}{{A}_{1}} \qquad ( 1 )$$

Further, if the pressure of the fluid is P1, then the force F1 applied on the piston 120 could be calculated using the following equation:

$${F}_{1} = {P}_{1} {A}_{1} \qquad ( 2 )$$

Further, as the piston 120 extends within the cylinder 116, hydraulic fluid is pulled or drawn from the reservoir 128 through a bypass check valve 210 into the second fluid chamber 136. As the piston 120 begins to extend, pressure in the second fluid chamber 136 is reduced below the pressure of the fluid in the fluid reservoir 128, and therefore the fluid in the fluid reservoir 128 flows through the bypass check valve 210 into the second fluid chamber 136 to fill the second fluid chamber 136.

As the piston 120 and the ram 208 extend, the moveable work head 180 and stationary work head 184 move toward each other in preparation for crimping, cutting, or punching a workpiece placed therebetween. As the moveable head 180 reaches the workpiece, the workpiece may resist movement by the moveable head 180 toward stationary head 184. Increased resistance to movement of the moveable head 180, and therefore the piston 120, can cause pressure of the hydraulic fluid supplied by the pump 112 to rise. As described further below, the increase in pressure supplied by the pump 112 may open the sequence valve 164 to increase the force acting on the workpiece by the moveable work head 180.

As described above, the tool 100 includes the sequence valve 164 configured to selectively supply fluid from the pump 112 to the second fluid chamber 136 to alter a speed and force at which the moveable head 180 advances toward the workpiece.

The sequence valve 164 includes a poppet 212 configured to open and close an inlet port 216 of the sequence valve 164. The sequence valve 164 may include spring 220 (or other biasing member) configured to bias the poppet 212 into a closed position (e.g., to engage a valve seat 217 defined by a body 218 of the sequence valve 164) to prevent flow through the inlet port 216 and therefore through the sequence valve 164. Additionally, the sequence valve 164 may include an outlet port 224 configured to connect the sequence valve 164 to the second fluid chamber 136. As such, moving the poppet 212 against the bias of the spring 220 causes the sequence valve 164 to move into the open position allows fluid supplied by the pump 112 to enter in the inlet port 216 and flow into the second fluid chamber 136 via the outlet port 224. The poppet 212 can move to the open position when the pressure acting on the area of an end of the poppet (e.g., a flange 219) overcomes the biasing force of the spring 220. The poppet 212 returns to the closed position when the forces acting to keep it open are reduced or removed. Specifically, when the hydraulic pressure in the first chamber 132 decreases below the threshold pressure required to overcome the spring 220 bias, the spring 220 automatically urges the poppet 212 back into engagement with the valve seat 217, thereby closing the sequence valve 164. Similarly, when the user interface component 160 is released or deactivated by the user, any external force applied to manually hold the poppet 212 in the open position is removed, allowing the spring 220 to return the poppet 212 to the closed position. This return to the closed position occurs regardless of whether the poppet 212 was initially opened by hydraulic pressure or manual actuation, as the spring 220 provides a consistent restoring force that ensures the sequence valve 164 defaults to the closed state when opening forces are no longer present.

During operation, the sequence valve 164 may be configured to automatically open to alter a speed and force at which the moveable head 180 advances toward the workpiece. For example, the fluid supplied by the pump 112 to the first fluid chamber 132 may be configured to act on the poppet 212. Specifically, once the fluid supplied by the pump 112 to the first fluid chamber 132 reaches a predetermined poppet pressure, the fluid may exert a force on the poppet 212 that exceeds the force applied by the spring 220 on the poppet 212. The predetermined poppet pressure threshold is calibrated based on the specific application requirements and tool configuration, typically ranging from several hundred to several thousand pounds per square inch depending on the tool size and intended workpiece materials. The hydraulic pressure acts against a specific surface area of the poppet 212, creating a force that overcomes both the spring pre-load and any additional resistance forces within the valve assembly. As the pressure builds in the first fluid chamber 132, the force differential across the poppet 212 increases proportionally until the opening threshold is reached. Consequently, the poppet 212 is moved to an open position, allowing the fluid to enter the second fluid chamber 136. Once opened, the sequence valve 164 creates a fluid communication path that enables simultaneous pressurization of both chambers. The illustrated example of the sequence valve 164 is an example construction for illustration, and other sequence valve designs could be implemented, including pilot-operated valves, cartridge-style valves, or electronically controlled proportional valves that offer different response characteristics and pressure settings. Correspondingly, the principles described here can be applied to other sequence valve types or systems, for example, to include a user-actuatable flow control element (e.g., the poppet 212) to allow a user to manually activate the sequence valve.

As the sequence valve 164 is opened to allow the fluid to act on an area A2 of the piston head 188 (e.g., area A2) in addition to the area A1. Thus, the fluid may act on a larger cross section of the piston 120 (A1+A2). As described above, the pump 112 may supply a relatively consistent flow of the fluid. As such, using the same flow rate Q, used in equation (1), it can be determined that the piston 120 and the ram 208 may move at a speed equal to V2, where V2 can be calculated using the following equation:

$${V}_{2} = \frac{Q}{{A}_{1} + {A}_{2}} \qquad ( 3 )$$

As indicated by equation (3), V2 is less than V1 because of the increase in the area from A1 to (A1+A2). As such, the piston 120 and the ram 208 may slow down to a controlled speed that achieves a controlled, more precise working operation. Additionally, as the area on which the fluid is acting increases from A1 to (A1+A2) the force applied on the piston 120 also increases and can be calculated using the following equation:

$${F}_{2} = {P}_{2} ( {A}_{1} + {A}_{2} ) \qquad ( 4 )$$

F2 is greater than F1 because of the area increase from A1 to (A1+A2). Thus, when the sequence valve 164 opens, high pressure hydraulic fluid can enter both the first fluid chamber 132 and the second fluid chamber 136 to cause a translation of the piston 120, and therefore the ram 208, to slow, and to cause a force applied by the ram 208 on the workpiece to increase. At the same time, the flow rate of fluid from the pump 112 may remain constant, but fills a greater volume per unit of extension of the piston 120. Thus, the piston 120 increase force output and reduces in extension speed.

In some examples, as higher pressure fluid fills the second fluid chamber 136 due to the opening of the sequence valve 164, the bypass check valve 210 may close, thus preventing fluid from the chamber 136 to flow back to the fluid reservoir 128.

Once the work piece is crimped, cut, or punched, and the piston 120 reaches an end of its stroke within the cylinder 116, hydraulic pressure of the fluid increases because the motor 108 may continue to drive the pump 112. This pressure increase occurs because the piston 120 can no longer advance further, while the pump 112 continues to supply fluid against to the cylinder 116. The hydraulic pressure may continue to increase until it reaches a threshold pressure value, which serves as an indication that the work operation has been completed, and the tool has reached its maximum extension. This threshold pressure value can be predetermined based on the specific tool configuration, the type of work being performed, and safety considerations to prevent over-pressurization of the hydraulic system. In some examples, the hydraulic pressure within the cylinder 116 may be monitored by the sensor 152 (as shown in FIGS. 2 and 3), which can be a pressure transducer, pressure switch, or other suitable pressure sensing device capable of detecting when the system pressure reaches the predetermined threshold. The sensor 152 provides real-time feedback to the controller 140, enabling precise control over the tool's operation cycle. Once the controller 140 receives information from the sensor 152 (as shown in FIGS. 2 and 3) indicating that the pressure reaches the threshold pressure value, the controller 140 may shut off the motor 108 and activate the release valve 230 to allow pressurized fluid to return to the reservoir 128, thereby reducing system pressure and allowing the return spring 228 to retract the piston 120 and the ram 208 back to a desired position, such as a home or fully retracted position (as illustrated in FIG. 4). This automated retraction sequence ensures consistent tool operation and prepares the tool for the next work cycle while preventing damage from excessive pressure buildup.

In some examples, the hydraulic tool 100 includes a return spring 228 disposed in the first chamber 132, configured to return the piston 120 to the retracted position. The return spring 228 is affixed to the cylinder 116 and acts on the surface of the piston 120 to bias the piston 120 in a direction that is away from the work head 106. The return spring 228 provides a restoring force that ensures reliable retraction of the piston 120 after completion of a work operation, regardless of the orientation of the tool 100 during use. The spring force is calibrated to overcome friction forces within the hydraulic system while allowing the hydraulic pressure to easily overcome the spring bias during extension operations. During retraction of the piston 120, pressure of fluid in the first fluid chamber 132 and the second fluid chamber 136 may be higher than pressure in the reservoir 128. This pressure differential occurs because the hydraulic fluid within the chambers has been pressurized by the pump 112 during the work operation, while the reservoir 128 maintains a relatively low pressure, typically near atmospheric pressure. As a result, hydraulic fluid can be discharged from the first fluid chamber 132 through a release valve 230 back to the reservoir 128. The release valve 230 is configured to open when activated by the controller 140, creating a flow path that allows the pressurized fluid to return to the reservoir 128 and thereby reduce system pressure. At the same time, hydraulic fluid can be discharged from the second fluid chamber 136 through the high-pressure check valve 200 and the release valve 230 back to the reservoir 128. This dual-path fluid return system ensures that both chambers are properly depressurized during the retraction cycle, allowing the return spring 228 to effectively move the piston 120 back to its home position.

As described above, in some examples, the second user interface component 160 may allow the user to selectively open the sequence valve 164. Specifically, the second user interface component 160 may be utilized to selectively actuate the poppet 212 to the open position and allow fluid communication between the pump 112 and the second fluid chamber 136. As also described above, opening the sequence valve 164 to allow fluid communication to the first fluid chamber 132 and the second fluid chamber causes a decrease in speed of the piston 120. In some examples, the second user interface component 160 may be actuated to decrease the speed of the piston 120 prior to the work head 106 contacting the work piece. Decreasing the speed of the piston 120 may slow a translation of the moveable work head 180 relative to the stationary work head 184, allowing users to properly align the work head at a desired crimp, cut, or punch location on the workpiece. Reducing speed can also be accompanied by a greater force output to perform a crimping or cutting operation, or another work function. This user-controlled speed modulation provides operational advantages over conventional hydraulic tools that operate at a single, fixed speed throughout the entire stroke cycle. The ability to manually trigger the speed reduction allows operators to maintain rapid approach speeds when positioning the tool, thereby minimizing cycle time and improving overall productivity. Once the work head approaches the target location on the workpiece, the operator can engage the second user interface component 160 to immediately transition to the slower, more controlled speed without waiting for automatic pressure-based activation. This manual control is particularly beneficial when working with delicate materials, precision connectors, or in applications where exact positioning is important to the quality of the finished connection. The enhanced control also reduces the likelihood of operator error, as the slower speed provides more time for fine adjustments and ensures that the crimping, cutting, or punching operation occurs at the precise intended location. Furthermore, the increased force output that accompanies the speed reduction ensures that the tool can effectively complete the work operation even on challenging materials or in applications requiring higher compression forces. The combination of user-selectable timing and dual-speed operation makes the tool adaptable to a wide range of applications and operator preferences, enhancing both the versatility and usability of the hydraulic power tool in various work environments.

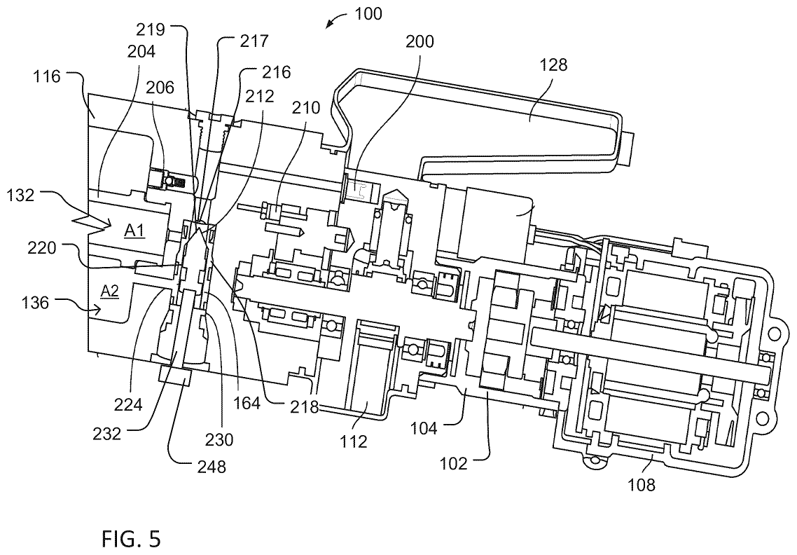

As mentioned above, various types of manual activation systems may be implemented to provide user control over the sequence valve 164, including mechanical linkages, direct actuation mechanisms, and electronic control interfaces that allow operators to selectively override the automatic pressure-based operation of the sequence valve. Referring to FIG. 5, in some examples, the sequence valve 164 may include a plunger 232 directly connected to the poppet 212. The plunger 232 can extend out of the valve body 218 to be engaged by a user to manually open the sequence valve 164.

In such examples, mechanically manipulating the plunger 232 may move the poppet 212 within the sequence valve 164, allowing a user to open the sequence valve 164 and therefore decrease an actuation speed of the tool 100. Specifically, the poppet 212 can be configured to move in a first direction along a longitudinal axis of the sequence valve 164, such as by translating linearly away from the valve seat 217 to create a fluid flow path between the inlet port 216 and the outlet port 224. The linear movement of the poppet 212 along the axis can be achieved through direct axial displacement of the plunger 232, which mechanically lifts or pulls the poppet 212 from its seated position against the biasing force of the spring 220. In alternative embodiments, the poppet 212 may be configured for rotational movement, where the poppet 212 rotates about the longitudinal axis or a transverse axis to align flow passages or move sealing surfaces out of engagement with the valve seat 217. Such rotational movement can be achieved through a threaded connection between the plunger 232 and the poppet 212, or through cam-actuated mechanisms that convert linear input motion from the user interface into rotational motion of the poppet 212. Additionally, the poppet 212 may be designed for combined translational and rotational movement, where initial rotation positions the poppet 212 for optimal flow characteristics, followed by axial translation to fully open the valve passage.

As illustrated in FIG. 5, the plunger 232 may extend from the poppet 212 allowing a user to pull or otherwise mechanically manipulate the plunger 232 to translate the poppet 212 within the sequence valve 164. Specifically, the sequence valve 164 may be opened by applying an external force to translate or otherwise move the plunger 232 to move the poppet 212 out of engagement with the seat 217. The external force required to actuate the plunger 232 can be calibrated to provide appropriate tactile feedback to the user while ensuring reliable operation under various working conditions. The force threshold may be set to prevent accidental actuation while remaining easily operable by the user during normal tool operation. The plunger 232 may include ergonomic features such as textured surfaces, finger grips, or contoured shapes to facilitate user manipulation and provide secure engagement even when the user is wearing work gloves or operating in challenging environmental conditions. Once the plunger 232 is no longer mechanically manipulated (e.g., the external force is removed), the sequence valve spring 220 may again close the sequence valve 164, thus increasing an actuation speed of the tool 100. The spring 220 provides a consistent restoring force that ensures the sequence valve 164 returns to its default closed position, maintaining system reliability and preventing unintended operation. However, in some examples, the sequence valve 164 may only close if the fluid pressure acting on the poppet 212 (e.g., against the bias of the spring 220) is less than the predetermined poppet pressure, as described above. This dual-mode operation allows the sequence valve 164 to remain open either through manual user actuation or automatic pressure-based activation, providing flexibility in tool operation and ensuring that the valve remains open when high-pressure conditions require continued dual-chamber operation. The poppet 212 can move independently of the second user interface 160 when the second user interface 160 is in a disengaged position (e.g., a first position when not being activated by a user) and is retained in the open position when the second user interface 160 is in an engaged position (e.g., a second position when being activated by a user). This independent operation capability ensures that the automatic pressure-based functionality of the sequence valve 164 is preserved even when the manual override feature is not being actively used by the operator. The disengaged position of the second user interface 160 allows the poppet 212 to respond freely to hydraulic pressure changes within the system, enabling seamless transition between manual and automatic operation modes. However, it is appreciated that in other examples, the sequence valve 164 may be configured so that the sequence valve 164 opens only through manual activation and does not open automatically based on a hydraulic pressure (e.g., by adjusting the biasing pressure on the poppet 212 or by using another type of sequence valve 164, such as a rotary valve).

When the second user interface 160 is in the engaged position, the second user interface 160 mechanically holds the poppet 212 in the open position, overriding any spring bias and maintaining dual-chamber operation regardless of system pressure conditions. In some examples, the second user interface 160 can be biased to the disengaged position. This biasing arrangement may be configured to automatically return the second user interface 160 to its neutral or disengaged state when not actively held by the user (e.g., via the second user interface 160).

In some examples, the hydraulic tool 100 may include a lockout mechanism 294 that can selectively retain the second user interface 160 in the engaged position, thereby maintaining the sequence valve 164 in the open position without requiring continuous user activation.

The lockout mechanism 294 may provide operational convenience in applications where extended dual-chamber operation is desired, allowing the operator to work with both hands free while maintaining the slower, higher-force operating mode throughout multiple work cycles. Alternatively, the lockout mechanism 294 may be configured to prevent actuation of the sequence valve 164, thereby maintaining the sequence valve 164 in the closed position to ensure high-speed operation of the ram 208. In such configurations, the lockout mechanism 294 may physically block or disable the second user interface 160, preventing inadvertent switching to the slower dual-chamber mode during operations where rapid or low-force movement is preferred, such as during initial positioning or when working with materials that do not require high force output.

Various types of lockout mechanisms may be implemented depending on the specific configuration of the second user interface 160. In some cases, a mechanical latch may be incorporated into the second user interface 160, where the latch engages with a corresponding feature on the tool housing 104 or valve assembly when the second user interface 160 is moved to the engaged position. The mechanical latch may include a spring-loaded detent, a cam-operated lock, or a friction-based retention system that securely holds the second user interface 160 in place until deliberately released by the operator.

In other examples, such as in FIG. 9, the lockout mechanism 294 may comprise a toggle-style arrangement where the second user interface 160 alternates between locked and unlocked states with successive actuations. The lockout mechanism 294 can move between a locked position and an unlocked position to control the operation of the second user interface 160. In the locked position, the lockout mechanism 294 may physically engage with the second user interface 160 or the sequence valve 164 to maintain the sequence valve 164 in either the open or closed position, preventing inadvertent changes to the valve state during operation. When the lockout mechanism 294 is moved to the unlocked position, the second user interface 160 is free to operate normally, allowing the user to actuate the sequence valve 164 between the open and closed positions as needed. The lockout mechanism 294 may include a spring-loaded detent, cam mechanism, or sliding collar that positively engages in both the locked and unlocked positions, providing tactile feedback to the user to confirm the current state of the lockout mechanism 294. Such a toggle mechanism may alternatively include internal ratcheting components or a bistable spring system that maintains the second user interface 160 in either the engaged or disengaged position until the next user input. In other cases, the lockout mechanism may include a sliding collar or rotating ring positioned adjacent to the second user interface 160. The collar or ring may be moved to a locking position that physically prevents the second user interface 160 from returning to the disengaged position, or may engage with internal components to maintain the sequence valve 164 in the open state. Such mechanisms may include visual indicators, tactile feedback, or audible clicks to confirm proper engagement of the lockout feature.

For electronically controlled implementations of the second user interface 160, the lockout mechanism may include a separate lockout switch or button that, when activated, maintains the electronic signal to keep the sequence valve 164 open or closed, regardless of the state of the primary second user interface 160. The electronic lockout may be integrated with the controller 140 to provide additional features such as automatic timeout functions, visual or audible indicators of lockout status, or integration with other tool safety systems.

The lockout mechanism 294 may also incorporate safety features to prevent unintended activation or to ensure proper release when required. For example, the lockout may include a two-step release process, require simultaneous activation of multiple controls, or include automatic release triggers based on tool orientation, pressure conditions, or elapsed time. These safety features may help ensure that the lockout mechanism enhances operational efficiency while maintaining safe tool operation under various working conditions.

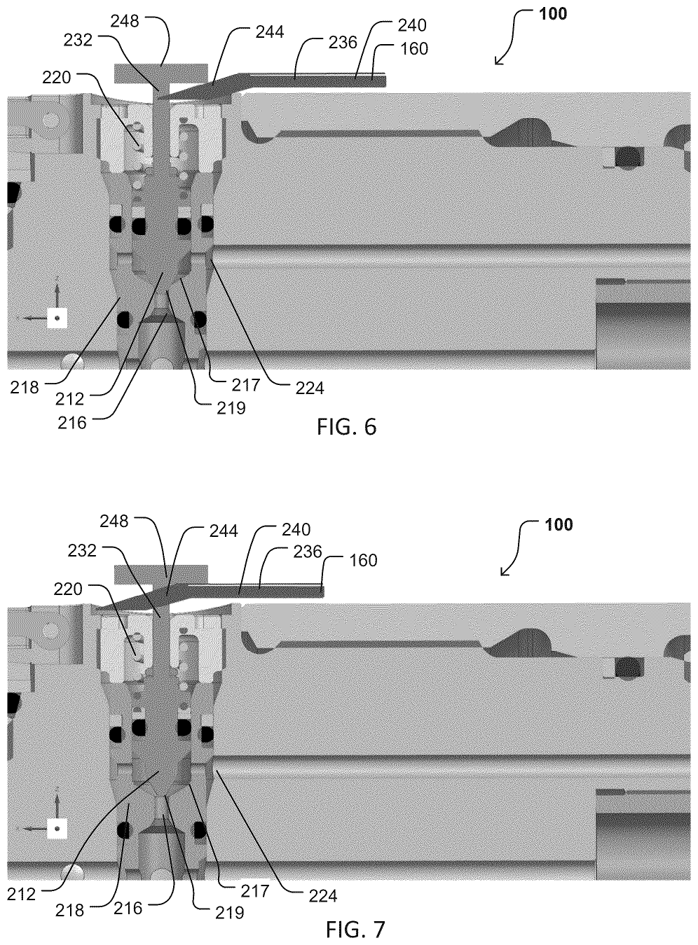

Referring to FIGS. 6-9, in some examples, the poppet 212 can be mechanically manipulated (e.g., translated) by a switch, a slide, a lever, or other type of the second user interface component 160. In such examples, the user may actuate the poppet 212, and therefore the sequence valve 164, to the open position without the aid of the controller 140, or another electronic actuator.

Referring to FIGS. 6 and 7, in some examples, the plunger 232 may be moveable to the open position by the second user interface component 160, here, configured as a sliding switch 236. The sliding switch 236 provides a direct mechanical interface that allows the user to manually override the automatic pressure-based operation of the sequence valve 164, giving the operator precise control over when the hydraulic tool 100 transitions from high-speed to high-force operation. For example, the user may move (e.g., translate) the sliding switch 236 in a first direction to engage the plunger 232 and move the poppet 212. Conversely, the user may move (e.g., translate) the sliding switch 236 in a second, opposite direction to disengage the plunger 232 and move the poppet 212. The sliding motion of the switch 236 can be configured as a linear translation along a predetermined path, which may be guided by rails, grooves, or channels formed in the housing 104, which may provide smooth and consistent operation.

In the illustrated example, the sliding switch 236 includes a base 240 that is engaged by a user and an extension 244. The base 240 may be ergonomically designed with textured surfaces, finger grips, or contoured shapes to facilitate user manipulation and provide secure engagement even when the operator is wearing work gloves or operating in challenging environmental conditions. The extension 244 can extend from the base 240 at a non-zero angle to form a ramped surface that is configured to engage a head 248 of the plunger 232 to move the poppet 212. The ramped configuration of the extension 244 provides a mechanical advantage that reduces the force required by the user to actuate the sequence valve 164 while ensuring positive engagement with the plunger head 248. The angle of the extension 244 can be optimized to balance case of actuation with the need for reliable valve operation. The angle can range from 5 to 15 degrees, 10 to 25 degrees, 15 to 30 degrees, 20 to 35 degrees, 25 to 40 degrees, or 30 to 45 degrees, etc., relative to the direction of switch travel.

In the illustrated example, the extension 244 may initially be disposed underneath a head 248 of the plunger 232 (e.g., between the head 248 and the exterior of the tool 100). This positioning ensures that the extension 244 is properly aligned to engage the plunger head 248 when the sliding switch 236 is actuated, while maintaining clearance during normal tool operation when the switch is not engaged. As the extension 244 is translated (e.g., slid) by the user toward the plunger 232 to act on the head 248, the head 248 can be moved by sliding engagement with the extension 244 to translate the plunger 232 and thus the poppet 212, consequently opening the sequence valve 164 (see FIG. 7). The sliding engagement between the extension 244 and the plunger head 248 creates a cam-like action that converts the horizontal motion of the sliding switch 236 into the vertical motion required to lift the poppet 212 from the valve seat 217. This mechanical arrangement provides tactile feedback to the user, allowing the operator to feel the valve's response and confirm successful actuation through the physical resistance and movement characteristics of the connected components. The sliding switch 236 may also include detent positions or spring-loaded mechanisms that provide positive feedback when the valve reaches the fully open position, ensuring reliable operation and preventing partial valve opening that could result in inconsistent tool performance.

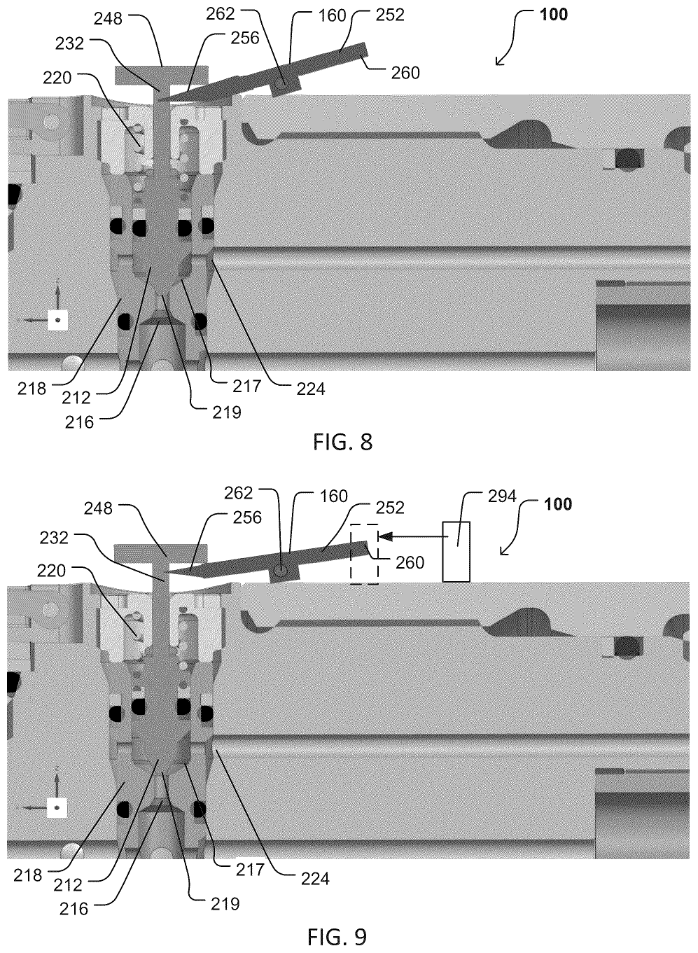

Referring to FIGS. 8 and 9, in some examples, the plunger 232 may be moveable to the open position by the second user interface component 160 that is configured as a lever switch 252. The lever switch 252 provides a mechanical advantage system that reduces the force required by the user to actuate the sequence valve 164 while providing precise control over valve operation. For example, a first lever end 256 of the lever switch 252 may initially be disposed underneath the head 248 of the plunger 232 (e.g., between the head 248 and the exterior of the tool 100). The first lever end 256 may include a contact surface or engagement feature that is shaped to interface with the plunger head 248, ensuring reliable engagement and preventing slippage during actuation.

Depressing a second lever end 260, opposite the first lever end 256, may rotate the lever switch 252 about a fulcrum 262, causing the first lever end 256 to translate the plunger 232 and thus the poppet 212, consequently opening the sequence valve 164 (see FIG. 9). The fulcrum 262 may be positioned to provide an optimal mechanical advantage ratio. That is a ratio of a length of the first lever end 256 to the second lever end 260 can range between 1:1 and 1:2, between 1:2 and 1:3, between 1:3 and 1:4, between 1:4 and 1:5, or between 1:5 and 1:7, etc. This can allow the user to apply a relatively small force at the second lever end 260 to generate sufficient force at the first lever end 256 to overcome the spring bias of the poppet 212. The lever switch 252 may be ergonomically designed with textured surfaces, finger grips, or contoured shapes at the second lever end 260 to facilitate user manipulation and provide secure engagement even when the operator is wearing work gloves.

When the second lever end 260 is released, the spring 220 bias of the poppet 212 may cause the lever switch 252 to return to its initial position, automatically closing the sequence valve 164 and returning the hydraulic tool 100 to single-chamber operation. This automatic return mechanism ensures that the hydraulic tool 100 defaults to high-speed operation when the user is not actively engaging the lever switch 252, provided that a current hydraulic pressure does not maintain the poppet 212 in the open position. The spring 220 provides sufficient restoring force to overcome any friction or resistance within the lever mechanism, ensuring reliable return to the closed position even after extended use or in challenging environmental conditions. The automatic closure feature also serves as a safety mechanism, preventing the tool from remaining in the slower, high-force mode inadvertently, which could lead to unexpected operational characteristics if the user is not aware of the valve state. Additionally, the spring-biased return system reduces operator fatigue by eliminating the need for the user to manually return the lever switch 252 to its initial position after each actuation cycle.

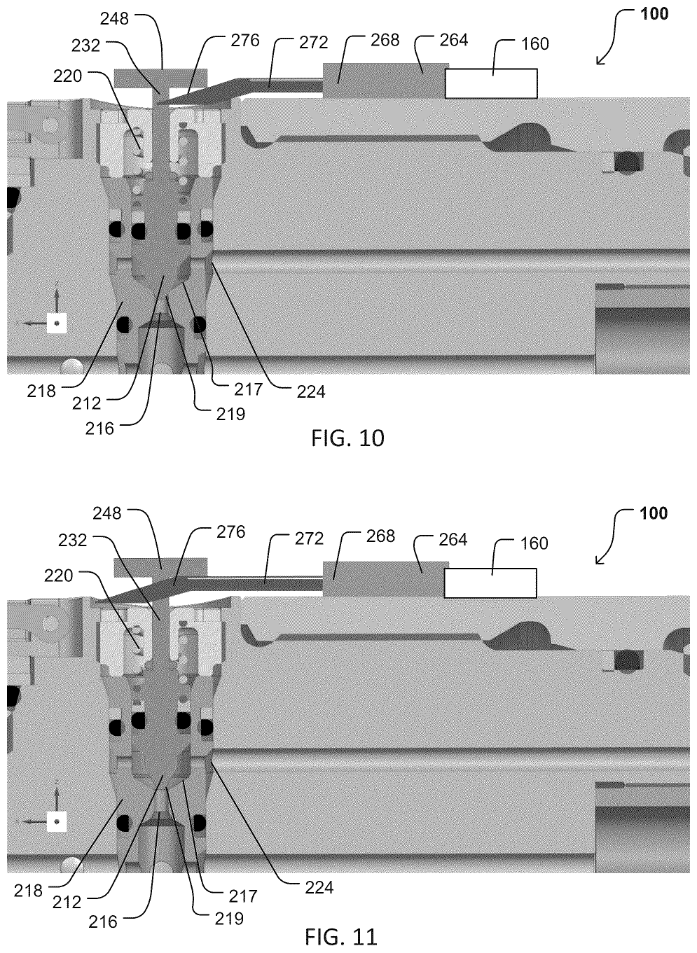

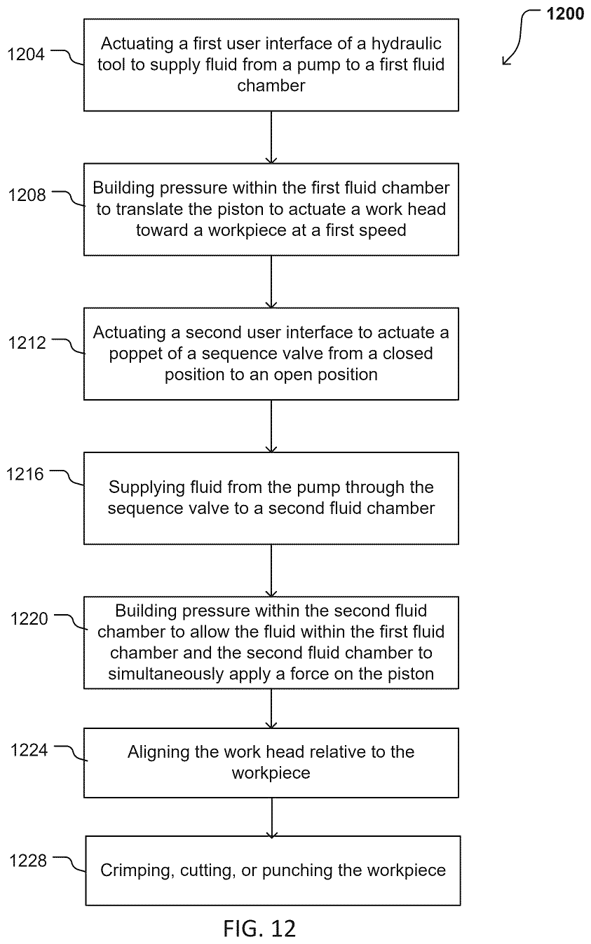

Referring to FIGS. 10 and 11, in some examples, the poppet 212 can be movable from the closed position to the open position using an electronic actuator 264, such as a linear actuator, a solenoid, a motor, or other type of actuator. The electronic actuator 264 provides precise control over the timing and force applied to actuate the sequence valve 164, enabling consistent and repeatable valve operation regardless of environmental conditions or operator variability. In such examples, the second user interface component 160 may be actuated to cause the controller 140 to actuate the poppet 212 utilizing the electronic actuator 264. The electronic actuator 264 can be configured to respond to various types of user inputs, including momentary button presses, toggle switches, variable position controls, or even proximity sensors that detect user intent without requiring physical contact. The controller 140 can process the input signal from the second user interface component 160 and generate appropriate control commands to energize the electronic actuator 264, which may include pulse-width modulation signals for proportional control, digital on/off commands for binary operation, or variable voltage/current signals for analog control. The electronic actuator 264 may include feedback mechanisms such as position sensors, force sensors, or current monitoring to provide the controller 140 with real-time information about the actuator's performance and the poppet's position.

Referring to FIGS. 10 and 11, in some examples, the plunger 232 may be moveable to the open position using an electronic actuator 264 that is in communication with the second user interface component 160 via the controller 140. The electronic actuator 264 provides precise, repeatable control over the sequence valve 164 operation and can be integrated with various control algorithms to optimize tool performance. For example, the user may actuate the second user interface component 160 that is a button, a slider, a trigger, or other user interface to cause the electronic actuator 264 to open the poppet 212. The second user interface component 160 may include tactile feedback mechanisms, visual indicators such as LED lights, or audible confirmation signals to provide the user with clear indication of the valve state. The controller 140 can process the input signal from the second user interface component 160 and generate appropriate control commands.

In the illustrated example, the electronic actuator 264 may be housed within an actuator housing 268 that provides protection from environmental contaminants, mechanical damage, and electromagnetic interference. The actuator housing 268 may be constructed from materials such as aluminum, steel, or reinforced polymers, and may include sealing elements such as O-rings or gaskets to prevent ingress of dust, moisture, or hydraulic fluid. The electronic actuator 264 (e.g., a solenoid, linear motor, piezoelectric actuator, or other linear actuator) may be configured to extend and retract an actuator base 272 also housed within the actuator housing 268. The electronic actuator 264 may operate on various voltage levels, such as 12V, 18V, 24V, or higher voltages depending on the power requirements and force output needed to reliably actuate the sequence valve 164. The actuator base 272 may include position feedback sensors, force sensors, or current monitoring capabilities to provide the controller 140 with information about the actuator's performance or the poppet's position. As similarly described above, the actuator base 272 may include a ramped extension 276 that provides mechanical advantage and smooth engagement with the plunger 232.

In other examples, the sequence valve 164 may itself be the electronic actuator 264, such as a solenoid valve. For example, the electronic actuator 264 may use electromagnetism to translate the poppet 212 within the sequence valve 164. In such configurations, the sequence valve 164 may be constructed as an integrated solenoid valve assembly where the electromagnetic coil is built directly into the valve body 218, eliminating the need for separate mechanical linkages or external actuators. The solenoid coil can be energized by the controller 140 in response to user actuation of the second user interface 160, creating a magnetic field that directly moves the poppet 212 against the spring 220 bias. In other examples, the electronic actuator 264 may be configured to open and close the poppet 212 using a lever mechanism, rotary actuator, linear motor, piezoelectric actuator, or other known actuator types. These alternative electronic actuators may provide different force characteristics, response speeds, or power consumption profiles depending on the specific application requirements. For example, a rotary actuator may convert rotational motion to linear poppet movement through cam or gear mechanisms, while a piezoelectric actuator may offer precise positioning with minimal power consumption.

FIG. 12 shows an example method 1200 of operating a power tool, such as for crimping, cutting, stamping, or otherwise performing work on a workpiece using the hydraulic tool 100 or another power tool. The method 1200 may include one or more operations, functions, or actions as illustrated by one or more blocks. Also, the various blocks may be combined into fewer blocks, divided into additional steps, and/or removed based upon the desired implementation. It should be understood that for this and other processes and methods disclosed herein, flowcharts show functionality and operation of one possible implementation of present embodiments. Alternative implementations are included within the scope of the example embodiments of the present disclosure in which functions may be executed out of order from that shown or discussed, including substantially concurrent or in reverse order, depending on the functionality involved, as would be understood by those reasonably skilled in the art.

Referring to FIG. 12 and method 1200, at block 1204, the method 1200 may include actuating a first user interface of a hydraulic tool to supply fluid from a pump to a first fluid chamber. The first user interface may be a trigger, button, or other actuatable control that initiates operation of the hydraulic tool. When actuated, the first user interface may cause a controller to activate a motor that drives the pump, thereby drawing hydraulic fluid from a reservoir and pressurizing it for delivery to the hydraulic system. The pump may be a positive displacement pump, gear pump, or other suitable pump type capable of generating sufficient pressure and flow rate for the intended application.

At block 1208, the method 1200 may include building pressure within the first fluid chamber to translate the piston to actuate a work head toward a workpiece at a first speed. As pressurized fluid enters the first fluid chamber, it acts on a first area of the piston, creating a force that overcomes any resistance from return springs or external loads. This initial phase of operation provides rapid approach speed, allowing the work head to quickly advance toward the workpiece, thereby reducing cycle time and improving operational efficiency.

At block 1212, the method 1200 may include actuating a second user interface to actuate a sequence valve from a closed position to an open position. The second user interface provides the operator with manual control over the transition from high-speed to high-force operation, allowing the user to determine the optimal timing for this transition based on visual feedback, workpiece positioning requirements, or specific application needs. This manual actuation capability allows the operator to override the automatic pressure-based operation of the sequence valve, providing enhanced control and flexibility during critical phases of the work operation.

At block 1216, the method 1200 includes supplying fluid from the pump through the sequence valve to a second fluid chamber. With the sequence valve opened, either through manual actuation or automatic pressure response, pressurized fluid from the pump can flow through the valve's inlet port, past the displaced poppet, and out through the outlet port to reach the second fluid chamber. This creates a dual-chamber pressurization system where both the first and second chambers receive pressurized fluid simultaneously.

At block 1220, the method 1200 includes building pressure within the second fluid chamber to allow the fluid within the first fluid chamber and the second fluid chamber to simultaneously apply a force on the piston. The simultaneous pressurization of both chambers increases the total effective area on which the hydraulic pressure acts, thereby increasing the total force output of the system while reducing the piston speed due to the increased volume that must be filled per unit of piston travel. This dual-chamber operation transforms the tool from a high-speed, lower-force configuration to a high-force, controlled-speed configuration.

At block 1224, the method 1200 may include aligning the work head relative to the workpiece. The reduced speed operation enabled by the dual-chamber configuration allows the operator to make fine adjustments to the position of the work head relative to the workpiece. This can allow a user to ensure proper alignment for optimal crimping, cutting, or stamping results. This alignment phase may involve visual inspection of the workpiece position, adjustment of the tool orientation, or repositioning of the workpiece within the work head. The slower, controlled movement provides the operator with sufficient time to achieve precise positioning, reducing the likelihood of misaligned operations that could result in defective connections or damaged components.

At block 1228, the method 1200 may include crimping, cutting, or stamping the workpiece. During this final phase, the high-force, controlled-speed operation enabled by the dual-chamber system allows the tool to perform the intended work function with precision and reliability. The increased force output ensures desired compression or cutting of the workpiece material. The work operation continues until the piston reaches the end of its stroke or until system pressure reaches a predetermined threshold indicating completion of the work cycle. Upon completion, the system may automatically retract the piston through activation of release valves and return springs, preparing the tool for the next work cycle.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Additionally, unless otherwise specified or limited, the terms “about” and “approximately,” as used herein with respect to a reference value, refer to variations from the reference value of ±15% or less, inclusive of the endpoints of the range. Similarly, the term “substantially equal” (and the like) as used herein with respect to a reference value refers to variations from the reference value of less than ±30%, inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

Also as used herein, ordinal numbers are used for convenience of presentation only and are generally presented in an order that corresponds to the order in which particular features are introduced in the relevant discussion. Accordingly, for example, a “first” feature may not necessarily have any required structural or sequential relationship to a “second” feature, and so on. Further, similar features may be referred to in different portions of the discussion by different ordinal numbers. For example, a particular feature may be referred to in some discussion as a “first” feature, while a similar or substantially identical feature may be referred to in other discussion as a “third” feature, and so on.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

The description of the different advantageous embodiments has been presented for purposes of illustration and description and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A power tool comprising:
a cylinder;
a ram movably received in the cylinder to define a first chamber and a second chamber;
a pump to supply fluid to the first chamber and the second chamber;
a sequence valve operable between a first configuration to cause the pump to supply fluid to the first chamber to move the ram at a first speed and a second configuration to cause the pump to supply fluid to the second chamber to move the ram at a second speed, the sequence valve moving from the first position to the second position based on a pressure in the first chamber; and
a user interface that is manually actuatable by a user to move the sequence valve between the first configuration and the second configuration independently of the pressure in the first chamber.

2. The power tool of claim 1, wherein the sequence valve includes a poppet that moves based on the pressure in the first chamber or by actuation of the user interface.

3. The power tool of claim 2 further comprising a housing that receives the cylinder, and the poppet including plunger that extends outside of the housing to be actuated by a user.

4. The power tool of claim 1, wherein the user interface is configured as one of a lever, a slider, a button, and a solenoid that applies an external force to the poppet.

5. The power tool of claim 4, wherein the user interface is directly mechanically coupled to the poppet.

6. The power tool of claim 4, wherein the user interface is mechanically coupled to the poppet via a linkage.

7. The power tool of claim 4, wherein the user interface is in communication with an electronic controller that activates an electronic actuator to move the poppet.

8. The power tool of claim 1, wherein the sequence valve attains the second configuration when the pressure in the first chamber reaches a threshold pressure and independently of actuation of the user interface.

9. The power tool of claim 1, further comprising a work head coupled to the ram to perform at least one of a crimping and a cutting operation.

10. A power tool comprising:
an actuator;
a pump to supply fluid to the actuator to cause the actuator to extend or retract, the pump defining an opening; and
a sequence valve including a valve body positioned in the opening in the pump, a control element moveable within the valve body between a first position and a second position, and a plunger that extends out of the valve body and is configured to receive a user input, the user input causing the control element to move between the first position and the second position to change a speed of the actuator between a first speed and a second speed.

11. The power tool of claim 10, wherein the user input is provided at a user interface component that is coupled to the plunger.

12. The power tool of claim 11, wherein the user interface component includes a mechanical linkage.

13. The power tool of claim 11, wherein the user interface component includes an electronic actuator.

14. The power tool of claim 11, wherein the control element moves from the first position to the second position based on a pressure of the fluid supplied to the first chamber independently of the user input.

15. The power tool of claim 11, wherein the control element is a poppet is engaged with a seat in the valve body in the first position and disengaged from the seat in the second position.

16. The power tool of claim 15, wherein the fluid is supplied to only a first chamber of the actuator when the poppet is in the first position, and
wherein the fluid is supplied to both the first chamber and a second chamber of the actuator when the poppet is in the second position.

17. A method of operating a hydraulic power tool, the method comprising:
actuating a first user interface of the hydraulic power tool to supply fluid from a pump to a first fluid chamber to move a ram at a first speed; and
manually actuating a second user interface to move a poppet of a sequence valve from a closed position to an open position to supply fluid from the pump to a second fluid chamber to move the ram at a second speed that is different from the first speed, the second user interface being actuatable independently of a pressure in the first fluid chamber.

18. The method of claim 17, wherein manually actuating the second user interface includes actuating a mechanical linkage that directly engages the poppet to move the poppet from the closed position to the open position.

19. The method of claim 18, wherein the mechanical linkage comprises one of a sliding switch, a lever switch, or a button that mechanically displaces the poppet against a biasing force of a spring.

20. The method of claim 17, wherein manually actuating the second user interface includes operating an electronic switch that causes an electronic actuator to move the poppet from the closed position to the open position.
